(19) United States
(12) Patent Application Publication
(10) Pub. No.: US 2007/0110998 A1
(43) Pub. Date: May 17, 2007

(54) Polyamide yarn spinning process and modified yarn

(76) Inventors: Ronald Edward Steele, Hixson, TN (US); Gregory David D'Arcy, Garza Garcia (MX)

Correspondence Address: INVISTA NORTH AMERICA S.A.R.L., THREE LITTLE FALLS CENTRE/1052, 2801 CENTERVILLE ROAD, WILMINGTON, DE, 19808, US

(21) Appl. No.: 11/274,620

(22) Filed: Nov. 15, 2005

(51) Int. Cl. B29D 7/00; B32B 19/00

(52) U.S. Cl. 428/357; 264/165; 428/364

(57) ABSTRACT

Provided by this invention is a modified synthetic polyamide polymer yarn produced by an improved melt extrusion process. Yarn of this invention are either partially oriented yarns (POY) or drawn oriented yarns. The improved process provides for modification of a polymer in a melt extruder. Following this modification of the polymer, a filament forming process step is provided which is coupled to a drawing stage prior to winding a package of yarn.

### FIELD OF THE INVENTION

The invention relates to an improvement in synthetic polyamide polymer yarn production via melt extrusion and to a modified yarn provided by this process. More particularly, the improved process includes the steps of modifying a polymer in a melt extruder, passing the modified polymer melt to a filament formation stage, and onto a coupled process step prior to being would up as a package of yarn. Yarns produced according to the invention are optionally drawn, in a process coupled drawing stage to form either partially oriented yarns (POY) or drawn oriented yarns.

### BACKGROUND OF THE INVENTION

U.S. Pat. No. 4,721,650 (Nunning et al. and assigned to SOLUTIA INC.) discloses the trifunctional amine triaminononane (TAN) or 4-aminomethyl-1,8 octanediamine as a polymer chain branching agent to alter yarn properties in high speed spinning. In general, about 0.01 to 1 weight percent of TAN is employed with the N66 (polyhexamethylene adipamide) polymer having a relative viscosity (as measured in formic acid) of 50 to 80 to obtain the benefits described in the '650 patent. The benefits of TAN modified N66 polymer based yarns are most readily obtained for partially oriented yarns (POY). Accordingly, the '650 patent teaches TAN modified polymers for use in making POY and most advantageously applied in POY for draw texturing. In draw texturing, also called friction false twist texturing (FFT), the TAN modified polymer yarns could be drawn and textured at higher speeds according to the teachings of the '650 patent. POY is often called a feed yarn for FFT. It was hypothesized that the addition of small amounts of TAN effectively reduced the yarn's spin orientation making it a more suitable feed yarn. Spin orientation refers to the apparent yarn elongation via an aerodynamic drag force on the yarn as spin speeds increase. Consequently, the effect of TAN was to permit increases in spinning speeds and still retain sufficient yarn elongation to perform FFT of a feed yarn.

In previous work, the TAN was added to the polymer during polymerization in an autoclave. In subsequent processing steps the autoclave produced polymer with TAN modification was made into polymer flake. The flake polymer, also known as chips or granulated polymer, was then used in a polymer remelt operation and fed via a melt extruder to the filament yarn spinning process. At the spinning speeds of more commonly practiced spinning processes (>4800 meters per minute) significant spin orientation of the yarn takes place. However, TAN modified N66 polymer yarns also exhibited a strength loss as measured by tenacity. This strength loss could be overcome by the use of higher draw ratios in fully drawn yarns but was difficult to overcome in partially oriented yarns used in texturing due to the tension demands of the texturing process.

It is hypothesized that yarn strength loss, especially in POY, was due to the undesirable cross linking of some portion of the polymer and that this cross linked polymer is related to the autoclave addition process. With this prior art process, the TAN was injected over a short period of time into the autoclave creating a localized high concentration of branch polymer where the reaction continued to form cross links—the precursor to high molecular weight polymer or soft gel. Some evidence of this effect is the short autoclave life between cleaning (⅓to ½of normal polymer), the gel particles observed in the polymer, and the poorer spinning performance observed with polymer produced at the end of the autoclave life.

### SUMMARY OF THE INVENTION

The invention provides an improved process for spinning a synthetic polyamide multifilament yarn from a polyamide polymer, modified prior to a spinning step, which includes the steps of providing a melt extruder with polyamide polymer chips, melting the chips and forwarding the melted polymer to an extrusion die during a period of time, forming at least a single filament, quenching the filament in a draft of air, forwarding the quenched filament using a feed roll assembly into a drawing zone, wherein the filament is optionally drawn and thereby increasing its length by an amount determined by a draw ratio; the draw ratio is independently chosen and equal to a quotient formed by the surface speed of the draw roll assembly to the surface speed of the feed roll assembly, and forwarding the optionally drawn filament to a winding assembly and winding up the filament on tube core. Herein, the improvement to this process may include contacting at the entrance to the extruder and prior to melting the polymer a triamino compound, capable of reacting with the polymer, e.g. branching the polymer, such that the time period during which the triamino compound and polymer are in a molten state is less than or about 12 minutes.

According to an embodiment of the invention a process for spinning a polyamide multifilament yarn comprising the steps of: providing to a melt extruder polyamide polymer chips, melting the polymer chips and forwarding the melted polymer to an extrusion die during a time period, forming filaments, quenching the filaments, optionally drawing the filament according to a draw ratio and winding up the filament; the improvement comprising: providing at the entrance to the extruder and prior to melting the polymer a triamino compound, capable of branching the polymer, such that the time period where the triamino compound and polymer are melted is less than about 12 minutes.

According to an embodiment of the process of the invention the triamino compound is selected from the group consisting of TAN (triaminononane and also known as 4-aminomethyl-1,8-octanediamine) and TREN (tris-(2-aminoethyl) amine).

According to an embodiment of the process of the invention the draw ratio is about 1 to about 2.

According to an embodiment of the invention provided is a synthetic polyamide yarn comprising nylon 66 polymer having a formic acid relative viscosity (RV) of about 40 to about 55 and having an elongation at break of about 60% to about 100%, having a TAN content by weight of about 0.01 to 0.10 per cent, wherein the yarn is provided according to a process including the steps of: providing to a melt extruder polyamide polymer chips, providing TAN at the entrance to the extruder and prior to melting the polymer, such that the time period during which TAN and polymer are melted is less than about 12 minutes, forwarding the melted polymer to an extrusion die during a time period, forming filaments, quenching the filaments, converging the filaments into a yarn and passing the yarn to a process step having a draw ratio of about 1.0 and winding up the yarn.

According to an embodiment of the invention provided is a synthetic polyamide yarn comprising nylon 66 polymer having a formic acid relative viscosity (RV) of about 40 to about 55 and having an elongation at break of less than about 60%, having a TAN content by weight of about 0.01 to 0.10 per cent, wherein the yarn is provided according to a process including the steps of: providing to a melt extruder polyamide polymer chips, providing TAN (a triamino compound) at the entrance to the extruder and prior to melting the polymer, such that the time period during which TAN and polymer are melted is less than about 12 minutes, forwarding the melted polymer to an extrusion die during a time period, forming filaments, quenching the filaments, converging the filaments into a yarn and passing the yarn to a process step having a draw ratio of about 1.1 to about 2.0.

### BRIEF DESCRIPTION OF THE DRAWINGS

FIG. 1A. is schematic representation of a process apparatus of the prior art for modifying polyamide polymers using a triamino compound and melt spinning a polyamide yarn from the polymer.

FIG. 1B. is schematic representation of a process apparatus of the invention for modifying polyamide polymers using a triamino compound and melt spinning a polyamide yarn from the polymer.

FIG. 2. is graphical representation of a the yarn quality improvement achieved by the process of the invention in comparison with the prior art.

### DETAILED DESCRIPTION

The invention provides a synthetic polyamide polymer yarn produced via an improved melt extrusion process. The improved process can include the steps of: providing a polyamide polymer for melting in a screw-type extruder, modifying the polymer in the extruder with a triamino compound while melting the polymer, passing the modified polymer melt to a filament formation stage, forming filaments from the polymer melt by passage through a spinneret plate having a capillary orifice for each filament, cooling and solidifying the filaments in conditioned air, converging the filaments into a yarn, applying a primary yarn finish oil to the yarn, forwarding the yarn to a coupled draw stage, optionally drawing the yarn according to a draw ratio which is equal to a quotient formed by the surface speed of the draw roll assembly to the surface speed of the feed roll assembly, and winding up the yarn as a package of multifilament yarn on a tube core. Such multifilament yarns produced according to the invention are either partially oriented yarns (POY) or fully drawn yarns (FDY) characterized by their respective elongations at break and determined according to a process draw ratio.

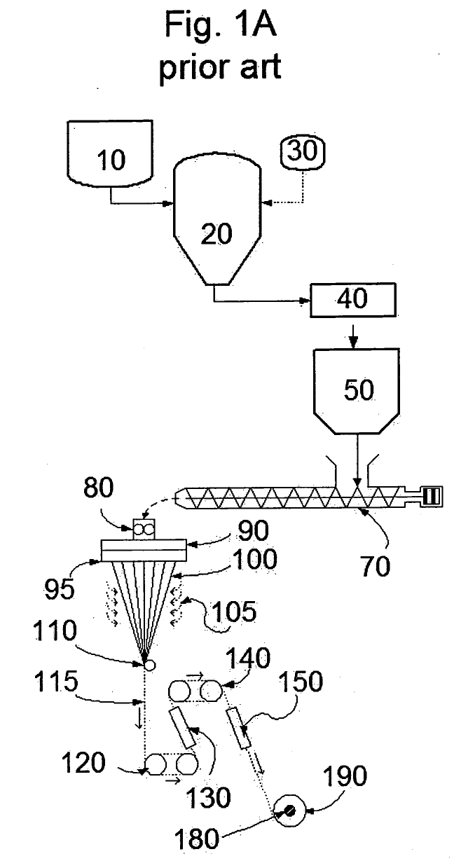

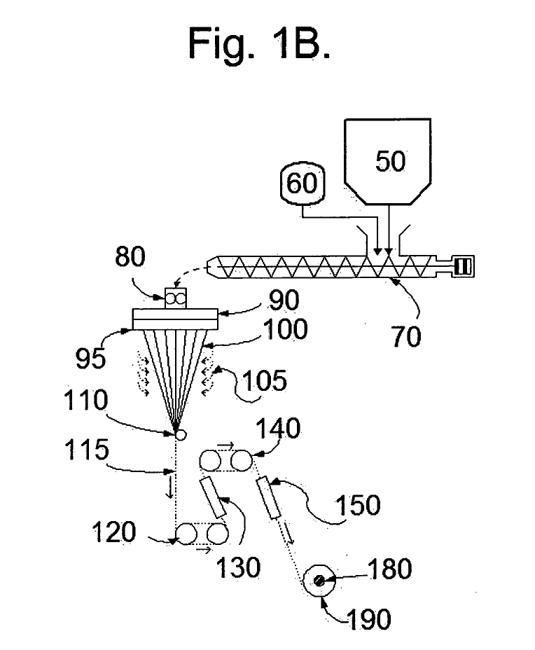

FIG. 1A. is schematic representation of a process apparatus of the prior art for modifying polyamide polymers using a triamino compound and melt spinning a polyamide yarn from the polymer. In FIG. 1A the vessel 10 provides nylon 66 salt, polyhexamethylene diammonium adipate and optionally a copolyamide salt, to the autoclave 20 where the salt is polymerized under heat and pressure to form a nylon polymer. To the autoclave 20 the vessel 30 provides TAN, triaminononane, a trifunctional amine capable of branching the nylon 66 polymer. An amount of TAN equal to 0.075 to 0.125 mole percent is added according to a prior art process. The polymer modified with TAN is conveyed to apparatus 40 in FIG. 1A and pelletized or chipped into into polymer chip form, also called flake or granulate. The polymer chip is stored in vessel 50 for feeding to melt extruder 70 where the polymer is melted and passed to a melt spinning head where the melt is pressurized by meter pump 80, filtered through 90 and extruded through a spinneret plate 95 to form filaments 100. The filaments 100 are cooled in a blast of conditioned air 105 and converged to a yarn at 110 with simultaneous application of a finish oil. The converged yarn 115 is forwarded by feed roll assembly 120 through apparatus 130 where a hot fluid (for example steam) can be applied prior to the yarn passing over draw roll assembly 140. The feed roll assembly 120 and draw roll assembly 140 comprise a draw stage where the yarn can be draw by the differential in peripheral speeds between the feed roll and the draw roll assemblies. The ratio of their respective speeds (draw roll divided by feed roll) is the draw ratio. The yarn is forwarded from the draw roll assembly through a treatment zone 150 which can contain a heated fluid, for example steam, and then wound up as a package of yarn 190 around a tube core 180. Intermediary rolls between the draw rolls 140 and yarn package winder can be used to manage the yarn tension in winding to achieve a good package build. Optional intermingling of the yarn before winding is practiced to maintain good coherence of the yarn and giving the yarn a nodal structure. A general disclosure of polymer production and yarn spinning according to the forgoing description is provided in the monograph by F. Fourné, Synthetic Fibers, Machines and Equipment, Manufacture and Properties, Hanser Publishers, Munich, 1998; see especially Chapter 4.

FIG. 1B. is schematic representation of a process apparatus of the invention for modifying polyamide polymers using a triamino compound and melt spinning a polyamide yarn from the polymer. In FIG. 1B. the polymer chip is stored in vessel 50 for feeding to melt extruder 70. The polymer chip has a formic acid RV of about 45 before TAN is added. The vessel 60 provides TAN, triaminononane, a trifunctional amine capable of cross linking the nylon 66, for feeding to melt extruder 70. TAN is provided at the entrance to the extruder for mixing with polymer chip but prior to melting the polymer. The amount of TAN provided is about 0.05 to about 0.1 weight percent. In the extruder melting process the time period during which the triamino compound and polymer are melted is less than about 10 minutes. Afterwards, the polymer is melted and passed to a melt spinning head where the melt is pressurized by meter pump 80 filtered through 90 and extruded through a spinneret plate 95 to form filaments 100. The filaments 100 are cooled in a blast of conditioned air 105 and converged to a yarn at 110 with simultaneous application of a finish oil. The converged yarn 115 is forwarded by feed roll assembly 120 through apparatus 130 where a hot fluid (for example steam) can be applied prior to the yarn passing over draw roll assembly 140. The feed roll assembly typically has a peripheral speed of about 4300 to about 5900 meters per minute. The feed roll assembly 120 and draw roll assembly 140 comprise a draw stage where the yarn can be draw by the differential in peripheral speeds between the feed roll and the draw roll assemblies. The ratio of their respective speeds (draw roll divided by feed roll) is the draw ratio. In order to make a POY the draw ratio is about 1.0. The yarn is forwarded from the draw roll assembly through a treatment zone 150 which can contain a heated fluid, for example steam, and then wound up as a package of yarn 190 around a tube core 180. Intermediary rolls between the draw rolls 140 and yarn package winder can be used to manage the yarn tension in winding to achieve a good package build. Optional intermingling of the yarn before winding is practiced to maintain good coherence of the yarn and giving the yarn a nodal structure.

The partially oriented yarns (POY) according to the invention can include those characterized by an elongation to break of about 70 percent to about 95 percent. The POY elongation to break is determined by the feed roll speed of the process. At feed roll speed of 4400 meters per minute a POY elongation of 93% is obtained, while at a feed roll speed of 5900 meters per minute a POY elongation of 70% is obtained. This relationship is substantially linear and allows a range of elongations.

It is observed that POY productivity is positively impacted with the use of TAN. For example, the POY elongation at a given feed roll speed without TAN can be related to the process feed roll speed with an effective amount of TAN. In the case of 0.09 weight per cent TAN, a POY elongation of 85% is achieved at a feed roll speed of 5000 meters per minute. Without TAN the equivalent POY elongation of 85% is achieved at a feed roll speed of 3500 meters per minute. The process feed roll speed without TAN cannot be increased to provide a productivity increase without decreasing the POY elongation and making the yarn less suited for draw texturing.

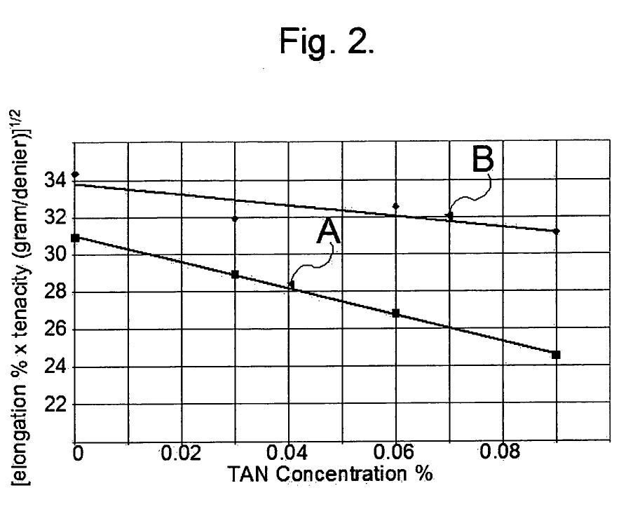

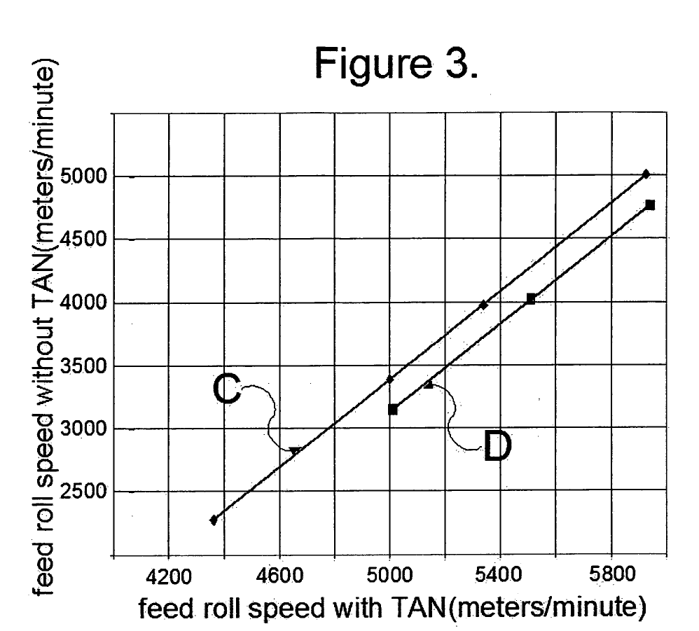

The yarns of the invention show an improvement in “quality index” defined as the square root of the product of elongation to break and tenacity (grams per denier). Quality approximates the area under the stress strain curve. This dependence upon TAN concentration is plotted for the two methods in FIG. 2.

Methods to prepare drawn yarns, also called fully drawn yarns or FDY are disclosed in U.S. Pat. No. 5,750,215 (Steele et al.), the disclosure of which is incorporated herein by reference. The Steele et al. '215 patent teaches a high spinning speed process for making highly oriented N66 yarns of long elongation to break, e.g. 22 to 60 per cent. However, increasing the elongation to break of the yarns prepared according to the methods of Steele et al. can be accomplished by changing the “slip ratio”; equal to the yarn speed to feed roll speed ratio in FIG. 5 of the '215 patent. Such a change is effectively the same as changing the draw ratio for the yarn. As a result, higher elongation partially oriented yarns can be prepared accordingly with elongations of >60% to about 100%. Drawn yarns or FDY according to the general teachings of the invention, containing TAN provided to the polymer by melt extruder addition, can be prepared using the methods and apparatus disclosed in the Steele et al. '215 patent.

As known in the art, nylon 66 based polyamides have polymer chain terminal amino groups and terminal carboxyl groups. Triamino compounds, e.g. TAN and TREN, can chemically react with one or, at most, three of the terminal carboxyl groups of the polyamide polymer chains. As a result of such reactions, the polymer becomes branched. Herein the meaning of branching is the capacity of a triamino compound to produce branched polyamide polymer. However, this definition of branching is meant in no way to be a limiting definition. Furthermore, this definition of branching is in no way a limiting or detailed description of any underlying chemical mechanism by which branched polymer is formed.

### Test Methods

Relative Viscosity (RV) of the polyamide refers to the ratio of solution and solvent viscosities measured at 25° C. in a solution of 8.4% by weight polyamide polymer in a solvent of formic acid containing 10% by weight of water.

### Test Methods

Tenacity and Break Elongation are measured for yarns according to ASTM D2256 using a 10 in (25.4 cm) gauge length sample, at 65% RH and 70 degrees F., at an elongation rate of 60% per min. Elongation to break is measured according to ASTM D955.

### Test Methods

A “quality index” is defined to be the square root of the quantity percent elongation to break multiplied by tenacity.
“quality index”=[% elongation X tenacity (grams/denier)]^{1/2}

### Test Methods

Boil-Off Shrinkage (BOS) is measured according to the method in U.S. Pat. No. 3,772,872 column 3, line 49 to column 3 line 66.

### X-ray Scattering

### Test Methods

X-ray scattering measurements were performed on data acquired through the National Synchrotron Light Source (NSLS) at Brookhaven National Laboratory in New York.

### Test Methods

The NSLS is a national user research facility funded by the U.S. Department of Energy's Office of Basic Energy Science. Two electron storage rings at NSLS provide an intense source of x-rays for chemistry/materials research with emphasis on polymers.

### Test Methods

Herein a combined small angle x-ray scattering (SAXS) and wide angle x-ray scattering (WAXS) technique was used to collect x-ray patterns of the yarns. A two dimensional analysis technique provided the spacing of amorphous regions, long period spacing, orientation angle, and the crystalline perfection index (CPI).

### Test Methods

Equivalent methods to obtain the SAXS and WAXS data are the following. A diffraction pattern of fiber of these compositions is characterized by two prominent equatorial X-ray reflections with peaks occurring at scattering angles approximately 20° to 21° and 23° 2θ. X-ray patterns were recorded on a Xentronics area detector (Model X200B, 10 cm diameter with a 512 by 512 resolution). The X-ray source was a Siemens/Nicolet (3.0 kW) generator operated at 40 kV and 35 mA with a copper radiation source (CU K-alpha, 1.5418 angstroms wavelength). A 0.5 mm collimator was used with sample to camera distance of 10 cm. The detector was centered at an angle of 20 degrees (2θ) to maximize resolution. Exposure time for data collection varied from 10 to 20 minutes to obtain optimum signal level.

### Test Methods

Data collection, on the area detector, is started with initial calibration using an Fe55 radiation source which corrects for relative efficiency of detection from individual locations on the detector. Then a background scan is obtained with a blank sample holder to define and remove air scattering of the X-ray beam from the final X-ray pattern. Data is also corrected for the curvature of the detector by using a fiducial plate that contains equally spaced holes on a square grid that is attached to the face of the detector. Sample fiber mounting is vertical at 0.5 to 1.0 mm thick and approximately 10 mm long, with scattering data collected in the equatorial direction or normal to the fiber axis. A computer program analyses the X-ray diffraction data by enabling one dimensional section construction in the appropriate directions, smoothes the data and measures the peak position and full width at half maximum.

The X-ray diffraction measurement of crystallinity in 66 nylon, and copolymers of 66 and 6 nylon is the Crystal Perfection Index (CPI) (as taught by P. F. Dismore and W. O. Statton, J. Polym. Sci. Part C, No. 13, pp. 133-148, 1966). The positions of the two peaks at 21° and 23° 2θ are observed to shift, and as the crystallinity increases, the peaks shift farther apart and approach the positions corresponding to the “ideal” positions based on the Bunn-Garner 66 nylon structure. This shift in peak location provides the basis of the measurement of Crystal Perfection Index in 66 nylon:
CPI=[d(outer)/d(inner)]−1×1/(0.189)×(100)
where d(outer) and d(inner) are the Bragg ‘d’ spacings for the peaks at 23° and 21° respectively, and the denominator 0.189 is the value for d(100)/d(010) for well-crystallized 66 nylon as reported by Bunn and Garner (Proc. Royal Soc. (London), A189, 39, 1947). An equivalent and more useful equation, based on 2θ values, is:
CPI=[2θ(outer)/2θ(inner)−1]×546.7

### X-ray Orientation Angle (Orient Angle)

The same procedures (as discussed in the previous CPI section) are used to obtain and analyze the X-ray diffraction patterns. The diffraction pattern of 66 nylon and copolymers of 66 and 6 nylon has two prominent equatorial reflections at 2θ approximately 20° to 21° and 23°. For 6 nylon one prominent equatorial reflection occurs at 2θ approximately 20° to 21°. The approximately 21° equatorial reflection is used for the measurement of Orientation Angle. A data array equivalent to an azimuthal trace through the equatorial peaks is created from the image data file.

The Orientation Angle (Orient. Angle) is taken to be the arc length in degrees at the half-maximum optical density (angle subtending points of 50 percent of maximum density) of the equatorial peak, corrected for background.

### Long Period Spacing (LP Space), and Long Period Intensity (LP Intensity)

The LP Space and LP Intensity are obtained from small angle X- ray scattering (SAXS) patterns recorded on a Xentronics area detector (Model X200B, 10 cm diameter with a 512 by 512 resolution). The X-ray source was a Siemens/Nicolet (3.0 kW) generator operated at 40 kV and 35 mA with a copper radiation source (CU K-alpha, 1.5418 angstroms wavelength). A 0.3 mm collimator was used with sample to camera distance of 40 cm. For most nylon fibers, a reflection is observed in the vicinity of 1° 2θ. The detector was centered at an angle of 0° (2. theta.) to maximize resolution. Exposure time for data collection varied from ½to 4 hours to obtain optimum signal level.

Data collection, on the area detector, is started with initial calibration using an Fe55 radiation source which corrects for relative efficiency of detection from individual locations on the detector. Then a background scan is obtained with a blank sample holder to define and remove air scattering of the X-ray beam from the final X-ray pattern. Data is also corrected for the curvature of the detector by using a fiducial plate that contains equally spaced holes on a square grid that is attached to the face of the detector. Sample fiber mounting is vertical at 0.5 to 1.0 mm thick and approximately 10 mm long, with scattering data collected in the meridional and equatorial direction. Scanning patterns were analyzed in the meridional direction and parallel to the equatorial direction, through the intensity maxima of the two scattering peaks. Two symmetrical SAXS spots, due to long period spacing distribution, were fitted with a Pearson VII function [see: Heuval et al., J. Appl. Poly. Sci., 22, 2229-2243 (1978)] to obtain maximum intensity, position and full-width at half-maximum.

The Long Period Spacing (LP Space) is calculated from the Bragg Law using the peak position thus derived. For small angles this reduces to 1.5418/(sin (2θ)). The SAXS Long Period Intensity (LP Intensity), normalized for one hour collection time; the average intensity of the four scattering peaks corrected for sample thickness (Mult.Factor) and exposure time, were calculated. The Long Period Intensity (LP Intensity) is a measure of he difference in electron density between amorphous and crystalline regions of the polymer comprising the filament; i.e.,
LP Intensity=[Average Intensity×Mult.Factor×60]/[Collect time(minutes)]

### EXAMPLES

This example illustrates the process of the invention to make a 100 denier 68 filament nylon 66 yarn which is partially oriented (POY). A process employing the spinning machine as represented by FIG. 1B. was used. All nylon 66 polymer flake used throughout these examples and comparative examples was 2.5% by weight copolyamide. This copolyamide content was provided by the addition of of 2-methyl pentamethylene adipamide salt to the hexamethylene adipamide salt. This polymer provided a yarn RV of 48 before addition of the TAN triamino compound. The TAN was added to the extruder with the polymer flake in an amount to provide 0.09 weight per cent. The residence time of the flake and TAN while melting in the extruder at 288° C. was less than 10 minutes. The 68 filament yarn was forwarded through a draw stage with no differential speed between feed roll assembly and draw roll assembly. The yarn acquired the same speed as the feed roll assembly speed, 5000 meters per minute. The elongation to break of this yarn was 85%.

In another trial with a 100 denier 68 filament count yarn the feed roll speed was increased to 5900 meters per minute. The yarn produced had an elongation of 70%.

This comparative example illustrates a prior process to make a 100 denier 68 filament nylon 66 yarn which is partially oriented (POY). A process employing the spinning machine as represented by FIG. 1A. was used. The polymer flake used provided a yarn RV of 48 before addition of the TAN triamino compound. The addition of TAN was observed to suppress RV by about 2-3 RV units in all trials. The final RV of the yarn was observed to be higher than that of the polymer flake in the presence and in the absence of TAN. The TAN was added to the autoclave which provided polymer flake with an amount of TAN equal to 0.09 weight per cent. The 68 filament yarn was forwarded through a draw stage with no differential speed between feed roll assembly and draw roll assembly. The yarn acquired the same speed as the feed roll assembly speed, 3500 meters per minute. The elongation to break of this yarn was 85%.

In another trial with a 100 denier 68 filament count yarn the feed roll speed was increased to 5000 meters per minute. The yarn produced had an elongation of 70%.

The above results are illustrated with reference to FIG. 3 showing two lines C and D. Line C is for a 100 denier yarn of 68 filaments. Line D is for a 100 denier yarn of 34 filaments. Each TAN containing yarn was prepared with 0.09% by weight of TAN in the polymer by the invention extruder addition method. The points comprising each line C and D are for a given feed roll speed and constant yarn elongation. The vertical axis is the feed roll speed at which a yarn of the same elongation would result in the absence of TAN in the polymer comprising the yarn. The lines C and D effectively show the yarn spinning productivity advantage of using TAN in the polymer. That is, a yarn containing TAN may be produced at a higher feed roll speed to provide a yarn of equivalent elongation versus a yarn without TAN. The higher productivity in spinning of TAN containing yarns provides yarns with sufficient elongation remaining in the yarn for downstream use in draw-texturing, e.g. POY.

Table 1 shows the x-ray wide angle scattering data compared for two nylon 66 yarns. The first yarn (40 denier 13 filaments) was produced by the autoclave addition method using the copolyamide polymer. The second yarn (95 denier 68 filaments) was produced by the invention extruder addition method of TAN to the copolyamide polymer. A 40 denier 13 filaments control yarn having no TAN was also prepared for the autoclave addition method. A control yarn of 95 denier 68 filaments yarn having no TAN was also prepared for the extruder addition method.

Table 2 shows the x-ray small angle scattering data compared for two identical yarns. The first yarn is produced by the extruder addition method and the second produced by autoclave addition method of TAN to the polymer.

These data in tables 1 and 2 show there exists a crystalline fine structure difference in the yarns produced by the two different methods of adding TAN. In summary, the autoclave addition process for TAN provides a yarn having a large change in crystal parameters, both size and perfection. There is an increase in amorphous phase fraction and larger space between crystals with an increase in the amorphous volume fraction. A small change in crystal volume fraction is observed, mostly due to a decrease in mesophase volume fraction.

By contrast the invention method of direct extruder addition provides a yarn a small or no change in crystal parameters. An increased amorphous level volume fraction with larger space between crystals is observed. A large rearrangement of crystalline character is observed where the percentage increase in crystalline volume fraction is compensated by a decrease in mesophase volume fraction.

TABLE 1
(Wide angle x-ray scattering)

| | | | | | | D100 | |
|---|---|---|---|---|---|---|---|
| | | | Xcr | Xm | Xu | (ångstrom) | CPI |
| | % TAN | OA | Crystal | Meso. | Amorph. | Apparent | Crystalline |
| Addition | (weight | Orientation | Volume | Volume | Volume | Crystal | Perfection |
| method | percent) | angle | Fraction | fraction | fraction | width | index |
| Autoclave | 0.0 | 11.2 | 0.171 | 0.434 | 0.395 | 65.2 | 67.63 |
| (yarn of 40 | | | | | | | |
| denier, 13 | | | | | | | |
| filaments) | | | | | | | |
| Autoclave | 0.09 | 11.7 | 0.174 | 0.394 | 0.432 | 67.8 | 74.51 |
| (yarn of 40 | | | | | | | |
| denier, 13 | | | | | | | |
| Extruder | 0.0 | 11.9 | 0.136 | 0.494 | 0.370 | 66.8 | 66.43 |
| (yarn of 95 | | | | | | | |
| denier, 68 | | | | | | | |
| filaments) | | | | | | | |
| Extruder | 0.09 | 12.5 | 0.154 | 0.431 | 0.415 | 66.6 | 65.77 |
| (yarn of 95 | | | | | | | |
| denier, 68 | | | | | | | |
| filaments) | | | | | | | |

TABLE 2
(Small angle x-ray scattering)

| | | Lc | La | Lp |
|---|---|---|---|---|
| | % TAN | (ångstrom) | (ångstrom) | (ångstrom) |
| | (weight | Crystal | Amorph. | Long |
| Addition method | percent) | height | height | period spac. |
| Autoclave | 0.0 | 28.6 | 45.5 | 74.1 |
| (yarn of 40 denier, | | | | |
| 13 filaments) | | | | |
| Autoclave | 0.09 | 30.6 | 51.1 | 81.7 |
| (yarn of 40 denier, | | | | |
| 13 filaments) | | | | |
| Extruder | 0.0 | 27.7 | 40.2 | 67.9 |
| (yarn of 95 denier, | | | | |
| 68 filaments) | | | | |
| Extruder | 0.09 | 28.7 | 43.8 | 72.5 |
| (yarn of 95 denier, | | | | |
| 68 filaments) | | | | |

The data presented as FIG. 2 show “quality index” as function of TAN concentration in weight per cent for the two routes for introduction of the triamino compound to the polymer. The quality index approximates the area under the stress strain curve and hence is indicative of yarn strength retention. The two curves A and B correspond to autoclave and extruder addition of TAN respectively. The slope ratio of A/B is (70.6/30) or 2.4. This ratio of the curves A and B in FIG. 2 indicates that the yarn strength, as a function of TAN content in the polymer, decreases more rapidly for the autoclave addition method—decreasing more than 2 times faster than the invention extruder addition method.

Those skilled in the art, having the benefit of the teachings of the present invention as herein and above set forth, may effect modifications thereto. Such modifications are to be construed as lying within the scope of the present invention, as defined by the appended claims.

What is claimed:

1. A process for spinning a polyamide filament comprising the steps of: providing polyamide polymer to a melt extruder; providing a triamino compound capable of branching the polyamide polymer; charging said triamino compound to said melt extruder at an injection point selected to provide sufficient contact time for said triamino compound and said polyamide polymer to form a melt polymer; melting said polyamide polymer; and extruding the melt polymer to form a filament.

2. The process of claim 1 further comprising quenching the filament.

3. The process of claim 2 further comprising drawing the filament.

4. The process of claim 3 further comprising winding up the filament.

5. The process of claim 1 wherein the contact time is less than about 12 minutes.

6. The process according to claim 1 wherein the triamino compound is selected from the group comprising TAN and TREN.

7. The process according to claim 1 wherein the draw ratio is about 1 to about 2.

8. A synthetic polyamide yarn comprising nylon 66 polymer having a formic acid relative viscosity (RV) of about 40 to about 55 and having an elongation at break of about 60% to about 100%, having a triamino compound content of about 0.01 to 0.10 weight percent, wherein the yarn is provided by the process according to claim 1 comprising a draw ratio of less than about 2.0.

9. The synthetic polyamide yarn of claim 8 comprising an elongation at break of less than about 60% and comprising a draw ratio of about 1.1 to about 2.0.

10. In a process for spinning a polyamide yarn comprising the steps of: providing to a melt extruder polyamide polymer chips, melting the chips and forwarding the melted polymer to an extrusion die during a time period, forming at least a filament, quenching the filament, optionally drawing the filament according to a draw ratio and winding up the filament; the improvement comprising: providing at the entrance to the extruder a triamino compound, capable of branching the polymer, characterized by a time period during which the triamino compound and polymer are formed into a melt polymer.

11. The process according to claim 10 wherein the time period during which the triamino compound and polymer are formed into a melt polymer is less than about 12 minutes.

12. The process according to claim 11 wherein the triamino compound is selected from the group comprising TAN and TREN.

13. The process according to claim 12 wherein the draw ratio is about 1 to about 2.

14. A synthetic polyamide yarn comprising nylon 66 polymer having a formic acid relative viscosity (RV) of about 40 to about 55 and having an elongation at break of about 60% to about 100%, having a triamino compound content of about 0.01 to 0.10 weight percent, wherein the yarn is provided by the process according to claim 1 comprising a draw ratio of about 1.0.

15. The synthetic polyamide yarn of claim 5 comprising an elongation at break of less than about 60% and comprising a draw ratio of about 1.1 to about 2.0.
